(19) United States
(12) Patent Application Publication
(10) Pub. No.: US 2023/0394313 A1
(43) Pub. Date: Dec. 7, 2023

(54) LTP-INDUCED ONLINE INCREMENTAL DEEP LEARNING

(71) Applicant: Actimize LTD., Ra'anana (IL)

(72) Inventors: Danny BUTVINIK, Haifa (IL); Yoav AVNEON, Ness-Ziyona (IL)

(21) Appl. No.: 17/831,159

(22) Filed: Jun. 2, 2022

(51) Int. Cl. G06N 3/08; G06N 3/04

(52) U.S. Cl. CPC G06N 3/084; G06N 3/0481

(57) ABSTRACT

The present disclosure provides a machine learning system and method configured to induce neuron activity in a neural network of the machine learning system. Each of the system and method selects a neural network with a multilayer perceptron and performs incremental learning cycle on the multilayer perceptron. An input neuron is modified by strengthening connections between the input neuron and additional neurons. A second input neuron may be modified by weakening connections between the second input neuron and additional neurons. Activation functions associated with the neurons in the multilayer perceptron may be adjusted. Batches of data are run through the multilayer perceptron until a set constraint is met, at which point a prediction is generated for each of the batches from input data from the neural network.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to deep learning models for online incremental learning, and more specifically to systems and methods for long-term potentiation (LTP) and/or long-term depression (LTD) induced online incremental deep learning for multilayer perceptrons.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized (or be conventional or well-known) in the prior art. The subject matter in the background section merely represents different approaches, which in and of themselves may also be inventions.

One of the challenges that currently exists with artificial and biological neural systems is the stability-plasticity dilemma. Learning in a parallel and distributed system requires plasticity for the integration of new knowledge, as a system that is too rigid will not change to account for trends in data or will change too slowly. However, stability is needed to prevent forgetting of previous knowledge, and therefore the system may not overcompensate for outlier data or other fleeting trends. Thus, there is a need to create a neural network training method that allows for efficient learning of evolving data over time while offering parameter tuning to control the level of dynamicity and elasticity of neural network models.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. In the figures, elements having the same designations have the same or similar functions.

FIG. 1 is an exemplary block diagram of a networked environment suitable for implementing the processes described herein according to an embodiment.

FIG. 2 is an exemplary diagram of a single-layer perceptron according to some embodiments.

FIG. 3 is an exemplary diagram of a multilayer perceptron according to some embodiments.

FIG. 4A is an exemplary diagrams of a modified multilayer perceptron after performing adjustments to increase weights between input neurons and downstream neurons during an inducement cycle according to some embodiments.

FIG. 4B is an exemplary diagrams of a modified multilayer perceptron after performing adjustments to decrease weights between input neurons and downstream neurons during an inducement cycle according to some embodiments.

FIG. 4C is an exemplary diagrams of a modified multilayer perceptron after performing adjustments to increase an activation function threshold during an inducement cycle according to some embodiments.

FIG. 4D is an exemplary diagrams of a modified multilayer perceptron after performing adjustments to increase an activation function threshold during an inducement cycle according to some embodiments.

FIG. 5 is an exemplary diagram of a flowchart for modifying a multilayer perceptron during an inducement cycle according to some embodiments.

FIG. 6 is an exemplary diagram of a flowchart of a training cycle incorporating an inducement cycle according to some embodiments.

FIG. 7 is an exemplary diagram of a computer system according to some embodiments.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

### Example Environment

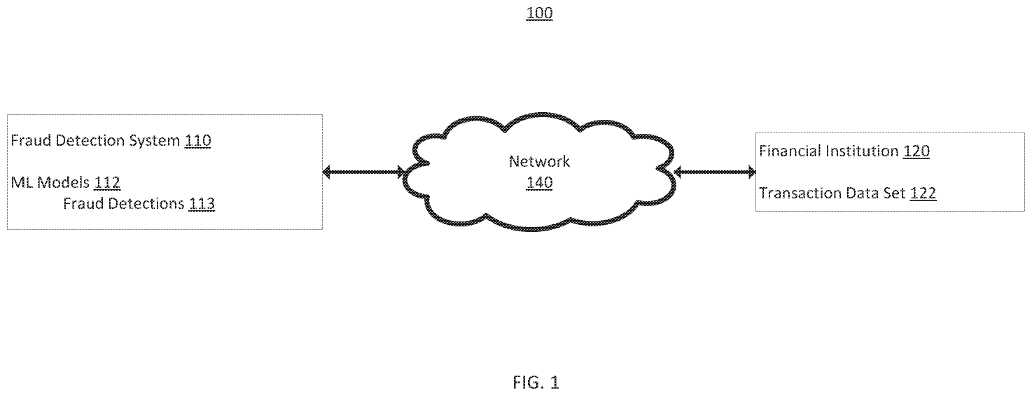

The system and methods of the present disclosure may include a machine learning (ML), neural network (NN), or other artificial intelligence (AI) computing architecture that is trained using long-term potentiation (LTP) and long-term depression (LTD). FIG. 1 is a block diagram of a networked environment 100 suitable for implementing the processes described herein according to an embodiment. As shown, environment 100 may include or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided, by such devices and/or servers may be combined or separated for a given embodiment and may be performed by a greater number or fewer number of devices and/or servers. For example, cloud-based architectures have been developed to improve collaboration, integration, and community-based cooperation between users without sacrificing data security. Similarly, ML and AI architectures have been developed to improve predictive analysis and classifications by systems in a manner similar to human decision-making, which increases efficiency and speed in performing predictive analysis, such as those during distribution of storage. One or more devices and/or servers may be operated and/or maintained by the same or different entities.

FIG. 1 illustrates a block diagram of an example environment 100 according to some embodiments. Environment 100 may include a fraud detection system 110 and a financial institution 120 that interact to provide intelligent detection of fraud detection, prevention, and/or other risk analysis operations through training of one or more ML models through LTP and LTD. In other embodiments, environment 100 may not have all the components listed and/or may have other elements instead of, or in addition to, those listed above. In some embodiments, the environment 100 is an environment in which fraud detection may be performed through an ML or other AI system. As illustrated in FIG. 1, fraud detection system 110 might interact via a network 140 with financial institution 120, which generates, provides, and outputs fraud detection and/or training for ML models.

Fraud detection system 110 may be utilized to train an ML model for fraud detection in low fraud scenarios using transaction data sets provided by financial institution 120. Financial institution 120 may correspond to a single entity, such as a bank or other financial institution, or may correspond to multiple different entities that provide segments and/or portions of transaction data set 121. Additionally, financial institution 120 may, in some embodiments, correspond to multiple different entities having different data sets for training and modeling of an ML model for fraud detection in low fraud scenarios. Prior to training one or more of ML models 112, fraud detection system 110 may perform data pre-processing on transaction data set 121, which may include data extraction and cleaning, fraud enrichment, data segmentation, and identification of low fraud scenarios in data segments. This may include steps such as data cleaning to remove or update one or more columns and/or features, sampling of training and testing data sets, normalizing to reduce the mean and provide missing value imputation, and/or feature engineering of features in the data sets that may be used for model training.

Thereafter, one or more initial ML models are generated and trained on the training data for each financial institution, segmented data set, and the like using an ML algorithm and technique. Specifically, training will occur on the one or more ML models through the use of LTP and LTD, detailed further below. Each initial ML model may be trained and selected based on the data set and scenario. These models are generated to provide risk or fraud predictions and/or scores on the data set at stake (e.g., transaction data set 121) for ML modeling for anomalous transaction and/or fraud detection. Thereafter, one or more hybrid ML models from ML models 112 may be deployed with intelligent fraud detection system 110 to perform fraud detections 113. LTP and LTD can continue to be implemented within the ML models 112 after training has completed, to allow the ML models 112 to continuously update and respond to changes in data over a period of time.

One or more client devices and/or servers may execute a web-based client that accesses a web-based application for fraud detection system 110, or may utilize a rich client, such as a dedicated resident application, to access fraud detection system 110. These client devices may utilize one or more application programming interfaces (APIs) to access and interface with fraud detection system 110 to schedule, review, and execute ML modeling using the operations discussed herein. Interfacing with fraud detection system 110 may be provided through an application and may be based on data stored by a database, fraud detection system 110, and/or financial institution 120. The client devices might communicate with fraud detection system 110 using TCP/IP and, at a higher network level, use other common Internet protocols to communicate, such as hypertext transfer protocol (HTTP or HTTPS for secure versions of HTTP), file transfer protocol (FTP), wireless application protocol (WAP), etc. Communication between the client devices and fraud detection system 110 may occur over network 140 using a network interface component of the client devices and a network interface component of fraud detection system 110. In an example where HTTP/HTTPS is used, the client devices might include an HTTP/HTTPS client commonly referred to as a “browser” for sending and receiving HTTP//HTTPS messages to and from an HTTP//HTTPS server, such as fraud detection system 110 via the network interface component. Similarly, fraud detection system 110 may host an online platform accessible over network 140 that communicates information to and receives information from the client devices. Such an HTTP/HTTPS server might be implemented as the sole network interface between the client devices and fraud detection system 110, but other techniques might be used as well or instead. In some implementations, the interface between the client devices and fraud detection system 110 includes load sharing functionality. As discussed above, embodiments are suitable for use with the Internet, which refers to a specific global internet of networks. However, it should be understood that other networks can be used instead of the Internet, such as an intranet, an extranet, a virtual private network (VPN), a non-TCP/IP based network, any LAN or WAN, or the like.

The client devices may utilize network 140 to communicate with fraud detection system 110 and/or financial institution 120, which is any network or combination of networks of devices that communicate with one another. For example, the network can be any one or any combination of a local area network (LAN), wide area network (WAN), telephone network, wireless network, point-to-point network, star network, token ring network, hub network, or other appropriate configuration. As the most common type of computer network in current use is a transfer control protocol and Internet protocol (TCP/IP) network, such as the global inter network of networks often referred to as the Internet. However, it should be understood that the networks that the present embodiments might use are not so limited, although TCP/IP is a frequently implemented protocol.

According to one embodiment, fraud detection system 110 is configured to provide webpages, forms, applications, data, and media content to the client devices and/or to receive data from the client devices. In some embodiments, fraud detection system 110 may be provided or implemented in a cloud environment, which may be accessible through one or more APIs with or without a correspond graphical user interface (GUI) output. Fraud detection system 110 further provides security mechanisms to keep data secure. Additionally, the term “server” is meant to include a computer system, including processing hardware and process space(s), and an associated storage system and database application (e.g., object-oriented data base management system (OODBMS) or relational database management system (RDBMS)). It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

In some embodiments, financial institution 120, shown in FIG. 1, executes processing logic with processing components to provide data used for ML model 112 training. For example, in one embodiment, financial institution includes an application server configured to implement and execute software applications as well as provide related data, code, forms, webpages, platform components or restrictions, and other information associated with data sets for ML model determination, and to store to, and retrieve from, a database system related data, objects, and web page content associated with fraud detection in transaction data sets. For example, fraud detection system 110 may implement various functions of processing logic and processing components, and the processing space for executing system processes, such as running applications for ML modeling and/or fraud detection. Financial institution 120 may be accessible over network 140. Thus, fraud detection system 110 may send and receive data to financial institution 120 via network interface components. Financial institution 120 may be provided by one or more cloud processing platforms, such as Amazon Web Services® (AWS) Cloud Computing Services, Google Cloud Platform®, Microsoft Azure® Cloud Platform, and the like, or may correspond to computing infrastructure of an entity, such as a financial institution.

Several elements in the system shown and described in FIG. 1 include elements that are explained briefly here. For example, the client devices could include a desktop personal computer, workstation, laptop, notepad computer, PDA, cell phone, or any wireless access protocol (WAP) enabled device or any other computing device capable of interfacing directly or indirectly to the Internet or other network connection. The client devices may also be a server or other online processing entity that provides functionalities and processing to other client devices or programs, such as online processing entities that provide services to a plurality of disparate clients.

The client devices may run an HTTP/HTTPS client, e.g., a browsing program, such as Microsoft's Internet Explorer or Edge browser, Mozilla's Firefox browser, Opera's browser, or a WAP-enabled browser in the case of a cell phone, tablet, notepad computer, PDA or other wireless device, or the like. According to one embodiment, the client devices and all its components are configurable using applications, such as a browser, including computer code run using a central processing unit such as an Intel Pentium® processor or the like. However, the client devices may instead correspond to a server configured to communicate with one or more client programs or devices, similar to a server corresponding to fraud detection system 110 that provides one or more APIs for interaction with the client devices to submit data sets, select data sets, and perform modeling operations for an ML system configured for fraud detection.

Thus, fraud detection system 110 and/or financial institution 120 (as well as any client devices) and all their components might be operator configurable using application(s) including computer code to run using a central processing unit, which may include an Intel Pentium® processor or the like, and/or multiple processor units. A server for fraud detection system 110, and/or financial institution 120 may correspond to Window®, Linux®, and the like operating system server that provides resources accessible from the server and may communicate with one or more separate user or client devices over a network. Exemplary types of servers may provide resources and handling for business applications and the like. In some embodiments, the server may also correspond to a cloud computing architecture where resources are spread over a large group of real and/or virtual systems. A computer program product embodiment includes a machine-readable storage medium (media) having instructions stored thereon/in which can be used to program a computer to perform any of the processes of the embodiments described herein utilizing one or more computing devices or servers.

Computer code for operating and configuring fraud detection system 110 and financial institution 120 to intercommunicate and to process webpages, applications and other data and media content as described herein are preferably downloaded and stored on a hard disk, but the entire program code, or portions thereof, may also be stored in any other volatile or non-volatile memory medium or device, such as a read only memory (ROM) or random-access memory (RAM), or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory integrated circuits (ICs)), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, virtual private network (VPN), LAN, etc.) using any communication medium and protocols (e.g., TCP/IP, HTTP, HTTPS, Ethernet, etc.) as are well known. It will also be appreciated that computer code for implementing embodiments of the present disclosure can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun MicroSystems, Inc.).

### Perceptrons and LTP/LTD Bias

An ML or NN model may include three groupings of layers—an input layer, one or more hidden layers, and an output layer having one or more nodes, however, different layers may also be utilized. The ML model may include fewer, or as many, hidden layers as necessary or appropriate. A perceptron as discussed herein includes an input layer, one or more hidden layers, and an output layer having one or more nodes. These nodes in each layer are connected to nodes in an adjacent layer. In this example, the ML model receives a set of input values and produces one output value. The output may correspond to a score and/or output classification of the input data. However, different, more, or fewer inputs, outputs, and/or hidden nodes may also be provided based on the training and desired structure of the ML model. When the ML model is used, each node in the input layer may correspond to a distinct attribute or input data type derived from the training data.

A perceptron is an NN unit—an artificial neuron—that performs computations to detect features or business intelligence in input data. Perceptrons are modeled after biological neurons. While biological neurons receive electrical signals from other neurons, in a perceptron these electronic signals are instead represented as numerical values passed through a neural network from one perceptron to another, where typically the perceptrons are located in different layers.

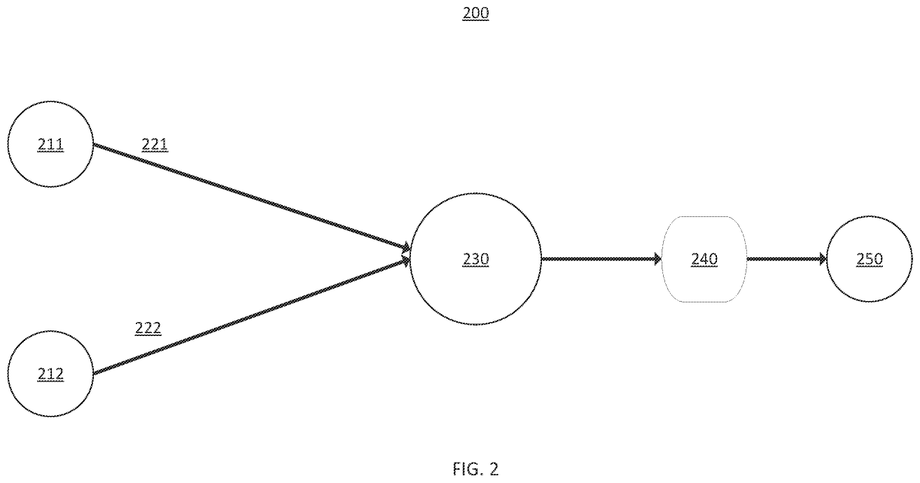

FIG. 2 is an exemplary block diagram 200 of a single-layer perceptron. Diagram 200 of FIG. 2 includes components of a single-layer perceptron, including input nodes, a downstream neuron, an activation function, and an output.

In diagram 200, one or more input neurons 211-212 pass input values to a single downstream neuron 230. Each input neuron 210 will have a weight 220 associated with it, which will modify the input values passed from input neurons 211-212 to the downstream neuron 230. downstream neuron 230 will then perform a calculation, such as a summation of each of the input values. The summation may be modified by a bias value associated with downstream neuron 230. The result of downstream neuron 230's calculation is then processed through an activation function 240, and an output 250 is generated.

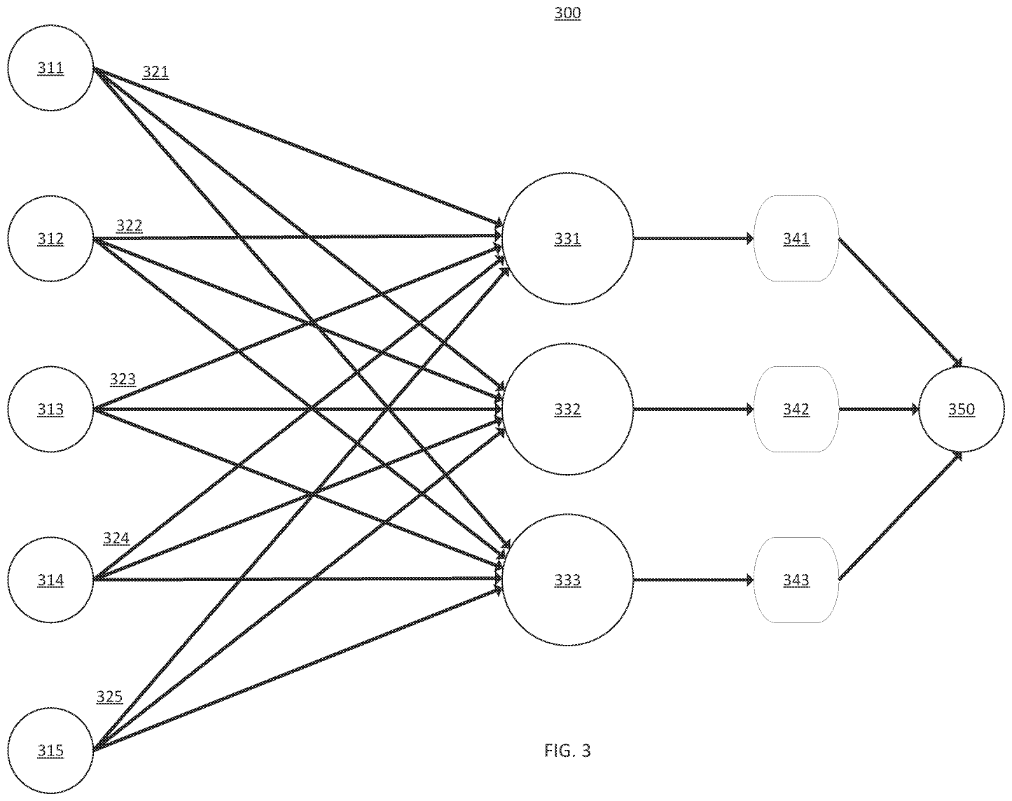

FIG. 3 is an exemplary diagram 300 of a multilayer perceptron. Unlike a single-layer perceptron, a multilayer perceptron will have more than one downstream neuron 330 associated with one or more input neurons 310 to produce an output 350. Accordingly, multilayer perceptrons are more complex than single-layer perceptrons. However, while the amount of data input and analyzed during training is larger, multilayer perceptrons perform the same underlying steps in training as single-layer perceptrons.

In a multilayer perceptron, input may come from one or more input neurons 310. Input neurons 310 provide input values to one or more of the downstream neurons 330. Each input neuron 310 has a weight 320 associated with each downstream neuron 330, which may modify the value of input neuron 310 when it is passed to an associated downstream neuron 330. Each downstream neuron 330 may perform a calculation using the weighted input values, such as performing a summation of the weighted input values. The calculation may be modified by a set bias value. This bias value may initially be set randomly. Each downstream neuron 330 may have an associated activation function 340. Activation function 340 may take the modified calculation from the downstream neuron 330 and determine whether the neuron should be activated. The information on which neurons are activated may then be used to generate a prediction about the input as output 350.

A multilayer perceptron may be trained by using training data, which may also be prepared by converting data to numerical representations and vectors. By providing training data to a multilayer perceptron, the nodes in any of the layers may be trained (adjusted) such that an optimal output (e.g., a classification) is produced in and output layer corresponding to output 350 based on the training data. By continuously providing different sets of training data and penalizing the multilayer perceptron when the output of the multilayer perceptron is incorrect, a multilayer perceptron (and specifically, representations of its nodes) may be trained (adjusted) to improve its performance in data classification. Adjusting a multilayer perceptron may include adjusting the weights associated with each node.

When training on new tasks or categories, a neural network tends to forget the information learned in the previously trained tasks. This usually results in the new tasks overriding the weights that have been learned in the past, leading to a degradation of the model performance for the past tasks. Thus, a model that has too much plasticity will suffer from large weight changes and forget previously learned representations. However, a model that is too stable will also present issues with learning, as it will not be able to consume enough new information from future training data to adapt sufficiently.

By altering the architecture of a deep neural network periodically by mimicking the process of LTP, where the communication between neurons is more active, and LTD, where the communication between neurons is attenuated, a balance for the stability-plasticity dilemma can be reached. These alterations create a smart flexibility within the structure of the deep neural network, as it is not flexible all the time in one place. Instead, flexibility will appear periodically in different places in the deep neural network, and the deep neural network will continue to adjust itself by the ongoing learning process.

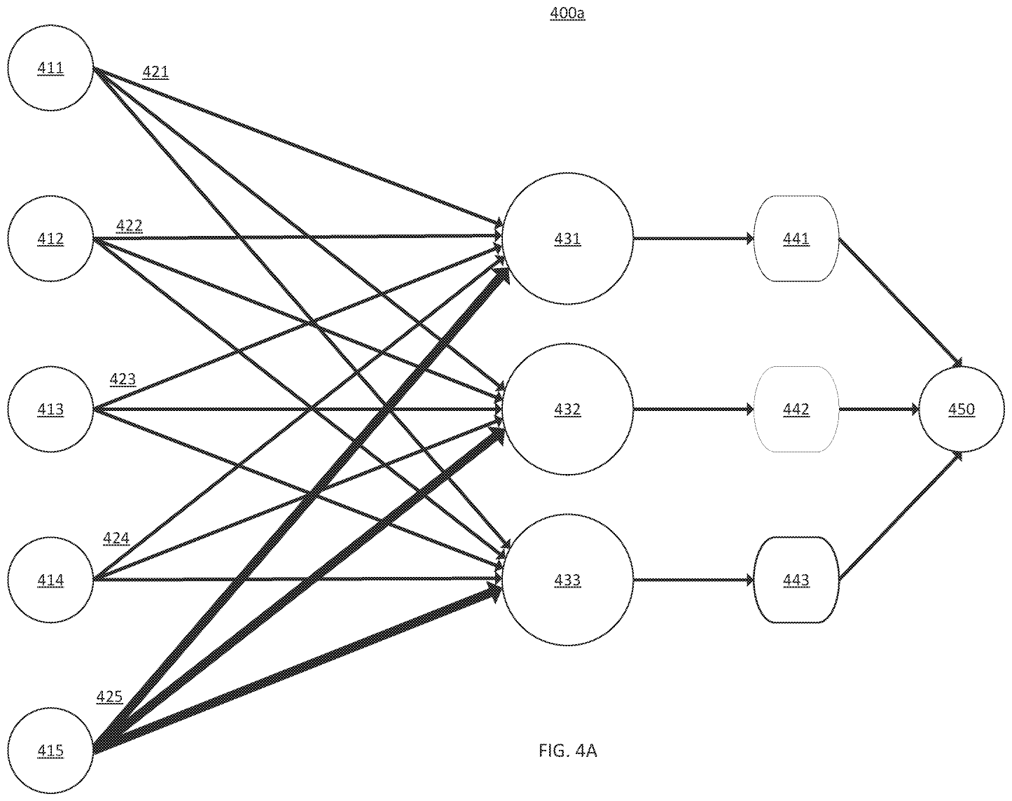

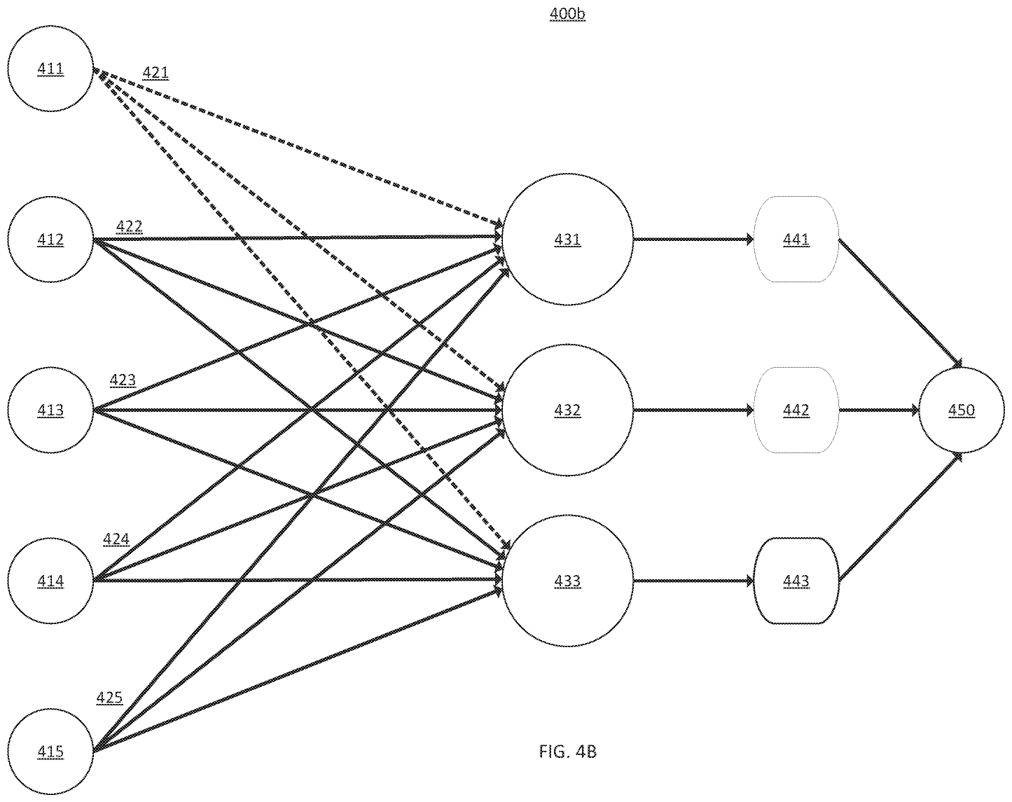

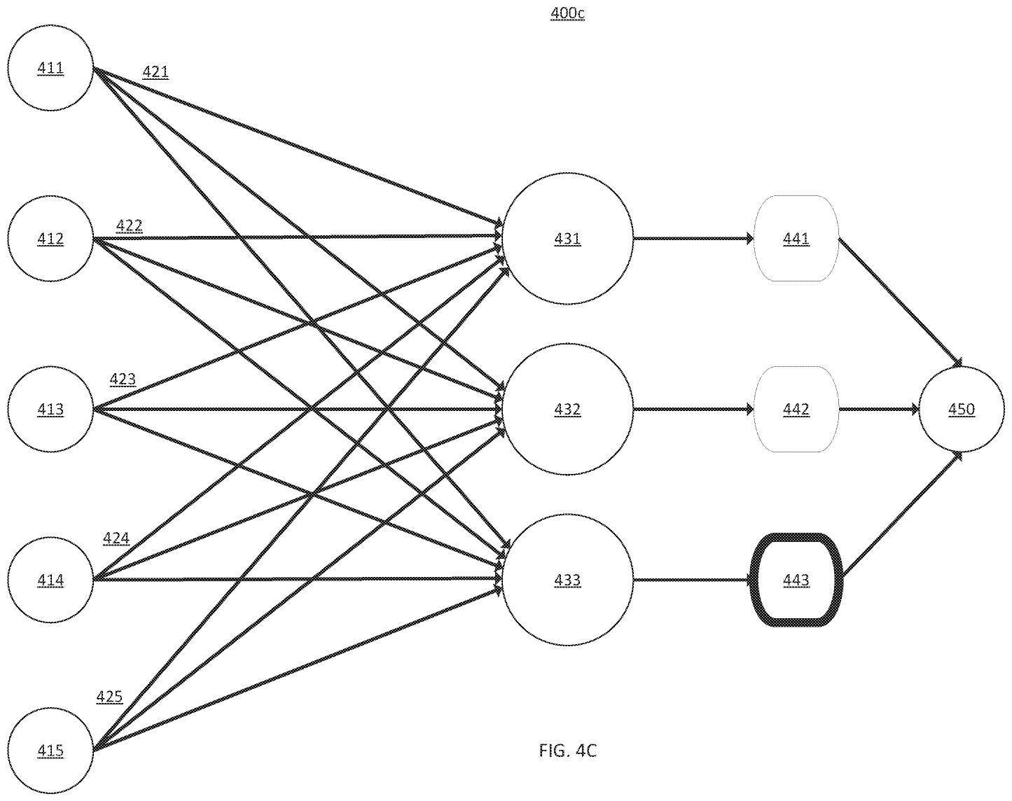

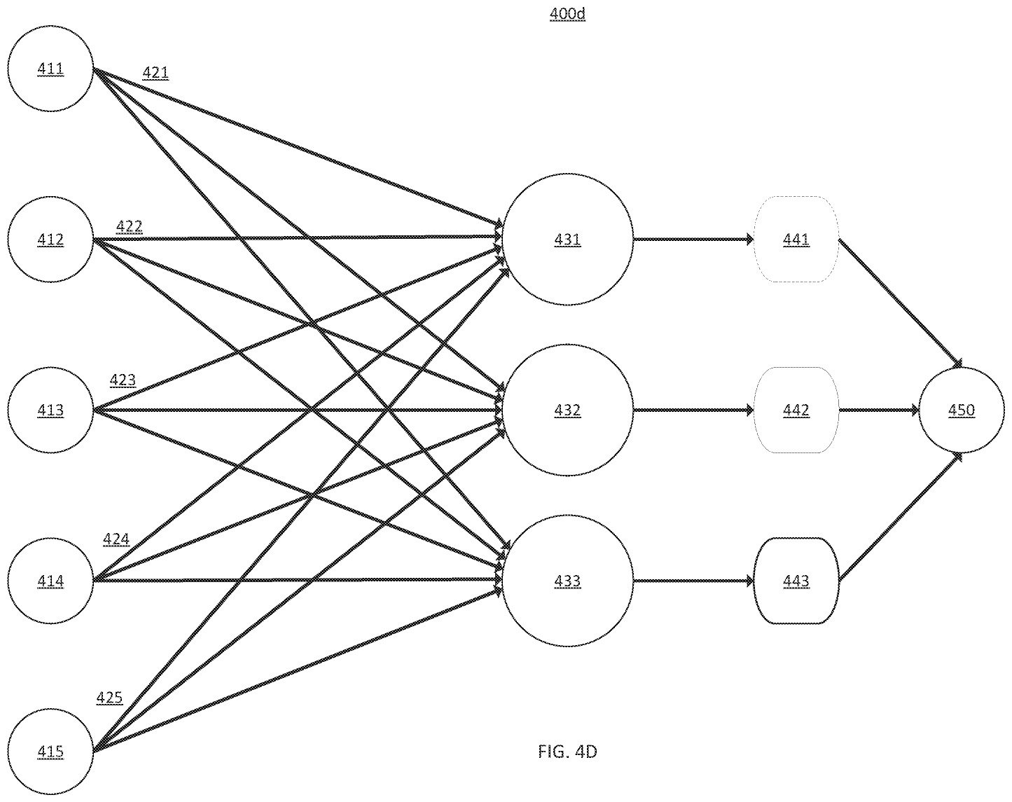

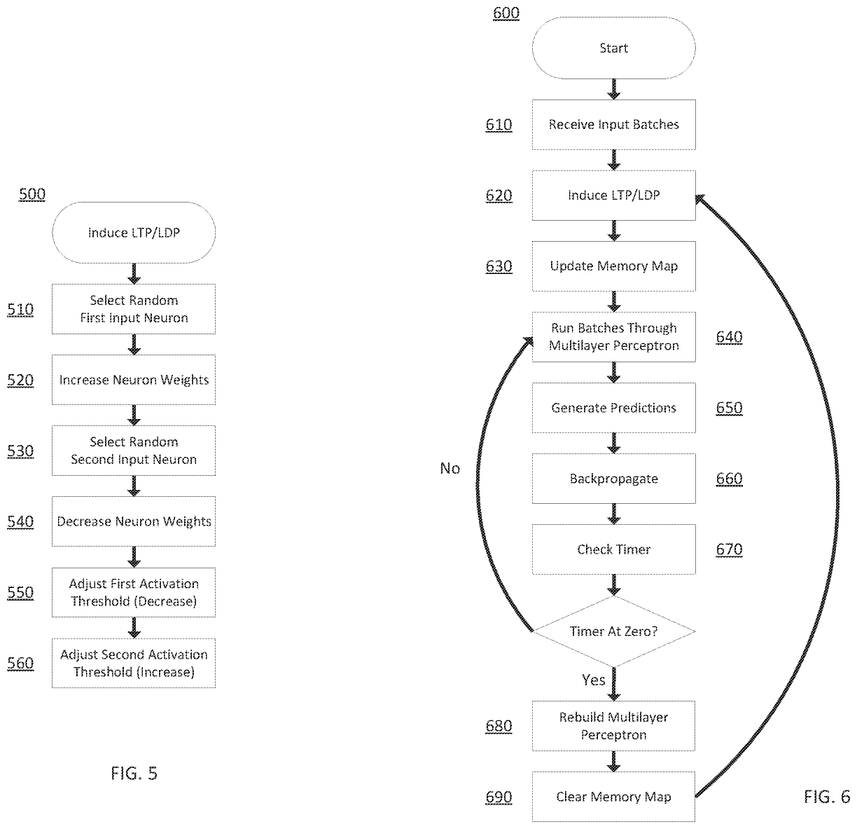

FIGS. 4A-4D are exemplary diagrams 400a-400d of a multilayer perceptron after performing adjustments to the multilayer perceptron of FIG. 3 during an incremental learning cycle according to some embodiments, according to various stages of the exemplary flowchart of FIG. 5.

Diagrams 400a-400d may therefore provide a modified structure of the multilayer perceptron by running incremental learning cycles. Incremental learning cycles may include various actions taken to mimic the process of LTP and LTD, to better allow the multilayer perceptron to learn while limiting forgetting.

The incremental learning cycle begins at step 510 by selecting a random input neuron. At step 520, modifications are made to weights associated with one or more downstream neurons from a selected random input neuron.

FIG. 4A reflects how a multilayer perceptron as seen in diagram 300 may be modified during step 520's increase to neuron weights. For input neuron 315, randomly selected as the first input neuron, weights 325 are increased. This strengthens the connections between input neuron 315 and downstream neurons 331-333, increasing the chance that downstream neurons activate. As a result, input neuron 415 in the modified multilayer perceptron as seen in simplified diagram 400a will now have higher weights 425 associated with each of the downstream neurons 431-433.

Each downstream neuron 331-333 may perform a calculation using the weighted input values from each input neuron 411-415, such as performing a summation of the weighted input values. Because the connections between input neuron 415 and downstream neurons 431-433 have been strengthened, weights 325 have been increased. As a result, weighted input values received by each downstream neuron will be higher. Weights 425 between input neuron 415 and downstream neurons 431-433 may be increased uniformly, or each weight may be increased by different amounts. Alternatively or additionally, one or more weights may not be increased at all.

A second random input neuron is selected at step 530. At step 540, modifications are made to weights associated with one or more downstream neurons from a second selected random input neuron.

FIG. 4B reflects how a multilayer perceptron as seen in diagram 300 may be modified during step 540's decrease to neuron weights. For input neuron 311, randomly selected as the second input neuron, weights 321 associated with one or more of downstream neurons 331-333 are decreased. This tends to weaken the connections between input neuron 311 and downstream neurons 331-333, decreasing the chance that downstream neurons activate. As a result, input neuron 411 in the modified multilayer perceptron as seen in simplified diagram 400b will now have lower weights 421 associated with each downstream neuron 431-433.

Each downstream neuron 331-333 may perform a calculation using the weighted input values from each input neuron 411-415, such as performing a summation of the weighted input values. Because the connections between input neuron 415 and downstream neurons 431-433 have been weakened, weights 325 have been decreased. As a result, weighted input values received by each downstream neuron will be lower. Weights 425 between input neuron 415 and downstream neurons 431-433 may be decreased uniformly, or each weight may be decreased by different amounts. Additionally or alternatively, one or more weights may not be decreased at all.

The second random input neuron may be a different neuron than was selected in step 520, or it may be the same neuron. By selecting the same neuron, weights may be adjusted such that some downstream neurons 431-433 have an increased weight associated with the selected input neuron, while other downstream neurons 431-433 have a decreased weight associated with the selected input neuron. Some downstream neurons 431-433 may have no change in weight associated with the selected input neuron.

At step 550, a first activation function associated with a downstream neuron is randomly selected and adjusted to decrease the activation function.

FIG. 4C. reflects how the multilayer perceptron in diagram 300 may be modified during step 550's decrease of an activation function. For example, activation function 341 may be randomly selected, resulting in a modified activation function 441 in the modified multilayer perceptron as seen in simplified diagram 400c. This lowers the minimum value needed for downstream neuron 431 to activate as compared to downstream neuron 331 in the original multilayer perceptron as seen in diagram 300, and thus increases the chance that downstream neuron 431 activates.

Each activation function 441-443 is initially set to produce an output based on the calculation by corresponding downstream neuron 431-433. For instance, if downstream neurons 431-433 are performing a summation of the weighted inputs, then the activation function may be as follows in the exemplary version below:

$$f ( x ) = \{ \begin{matrix}1 , & if \sum \geq x \\ 0 , & if \sum < x\end{matrix}$$

An activation function threshold x will determine what is output from activation function 440, based on a comparison to the calculation by corresponding downstream neuron 430. To increase the likelihood that a downstream neuron activates, the value of the activation function threshold will be decreased such that x is smaller and thus ƒ(x) will return 1 at a lower activation function threshold x.

At step 560, a second activation function associated with a different downstream neuron is randomly selected and adjusted to increase the activation function.

FIG. 4D reflects how multilayer perceptron as seen in diagram 300 may be modified during step 550's increase of an activation function. For example, activation function 343 may be randomly selected, resulting in a modified activation function 443 in the modified multilayer perceptron as seen in simplified diagram 400d. This raises the minimum value needed for downstream neuron 433 to activate as compared to downstream neuron 333 in the original multilayer perceptron as seen in diagram 300, and thus decreases the chance that downstream neuron 433 activates.

To decrease the likelihood that a downstream neuron activates, the value of the activation function threshold may be increased such that x is larger and thus ƒ(x) will return 1 at a higher activation function threshold x.

In some embodiments, the method and system may vary in the adjustments made during an incremental learning cycle, based on differing business needs for the neural network, server load, demand, or other interests. Different adjustments may be made to input neurons or activation function thresholds. The adjustments to the input neurons or activation function thresholds may be zero, to have the effect of not based on different business needs. Additionally, the order of the adjustments may change, or adjustments may be repeated for additional input neurons, for additional activation function thresholds, or both.

FIG. 6 shows an exemplary diagram of an exemplary flowchart of a training cycle incorporating an incremental learning cycle according to some embodiments.

In step 610, the neural network receives input batches of data. Input batches may be received at any point during the incremental learning cycle but may be run through the multilayer perceptron at step 640 when the system is ready for additional batches to be processed. In some embodiments, batch size may vary according to predefined rules, or batch size may be dynamically calculated by an automation process. While it is not necessary, batch sizes may be the same or may vary across various batches. In traditional incremental learning, a neural network receives batches of transactions from a data storage or data buffer. In online incremental learning, however, batches of data can instead be received directly from real-time streams. When the batches of input data come from data streams, the model will learn “on-the-fly” as evolving trends, patterns, and statistics within the data change over time. In some embodiments, the data stream may be buffered to allow the neural network to process the data in a predefined time framework, such as 5 transactions per second.

In step 620, the neural network induces LTP and LTD, as shown in FIG. 5. The adjustments to neuron weights and activation thresholds are applied to the multilayer perceptron. This will update the original multilayer perceptron in diagram 300 as seen in FIG. 3 and result in a modified multilayer perceptron that may reflect one or more of the changes as seen in FIGS. 4A-4D. The neural network then registers these changes into a memory map at step 630, so the neural network can be initialized at a later time.

In step 640, batches of input data are then run through the modified multilayer perceptron, generating predictions at step 650 for each batch of input data. During a training cycle, the multilayer perceptron may backpropagate at step 660 based on the outcome and expected result. If the expected result is returned, then no change needs to be made to the multilayer perceptron. However, if an unexpected result is generated, then weights can be updated based on the error ε, calculated based on the actual result and predicted result:

ε=actual result−predicted result

The error can be added to the value of the weights, scaled based on a set learning rate α. Typically, learning rates are set up between 0 and 1, which helps control how quickly the model is adapted to solve the problem. A higher learning rate may allow a model to adapt more quickly, but also runs the risk of the model oscillating and never converging on an ideal outcome. However, a lower learning rate may cause a model to adapt too slowly. By multiplying the error and learning rate, a modification value can be generated and applied to neuron weights to adjust the weights, and thus the likelihood that downstream neurons fire.

The batches of input data are run through the multilayer perceptron until a set time constraint at step 670 is met. If the time constraint has not been met, then additional batches of input data can be run through the modified multilayer perceptron at step 640, and the system will continue to generate predictions at step 650 and backpropagate at step 660 based on the predicted outcomes. The multilayer perceptron can continue to train on input batches using the same modifications while the timer is not yet zero.

When the time constraint at step 670 is met, the neural network goes through a rebuilding stage at step 680. The memory map is used to identify the impacted neurons, and the modified weights are reset to random values, as they were before the training started. The memory map is then cleared at step 690 and ready to store the changes made in the next incremental learning cycle. A new incremental learning cycle can then begin, with new random selections made to induce LTP/LTD at step 620 for the next set of adjustments.

Each incremental learning cycle is run for a set time constraint. The time constraint can be based on the amount of time that has passed since the start of the incremental learning cycle, based on seconds, computing cycles, or any other measurement of time. Alternative, the time constraint may be based, not on temporal duration that has passed since the incremental learning cycle began, but instead on a predetermined number of passes through each neuron within the multilayer perceptron. This can comprise a sum of the forward passes (e.g., evaluation) and backpropagation passes (e.g., feedback) through each neuron in the multilayer perceptron. When the predetermined number of total passes has been met, then the incremental learning cycle may end, the neural network may go through a rebuilding stage, and a new incremental learning cycle can then start.

Based on the needs of the system, the incremental learning cycle may instead be run until a non-time-based rule set is met. For instance, server load or demand may dictate when to start and stop the incremental learning cycle. The incremental learning cycle may be based on analyzing a set number of inputs. The cycle may be run until a set success rate, or set improvement in success, of correctly identifying inputs is met.

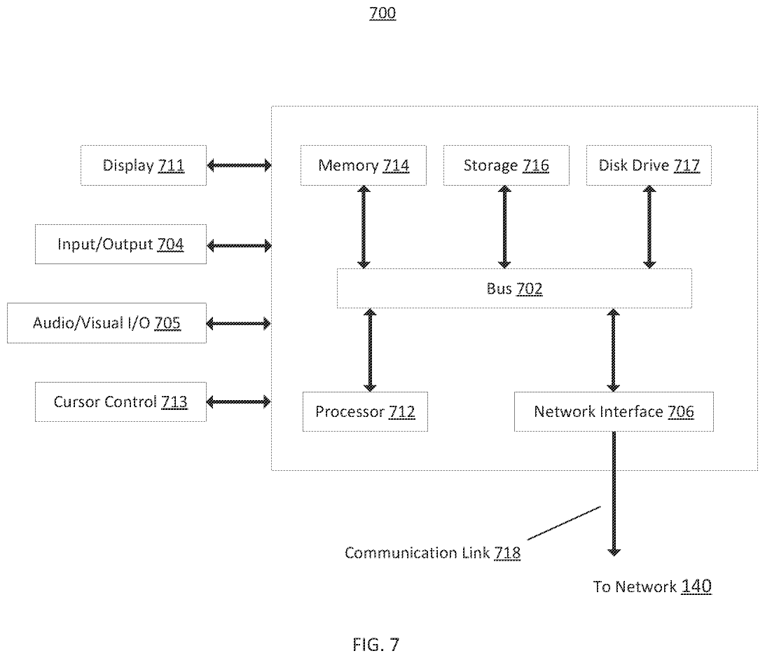

FIG. 7 is a block diagram of a computer system suitable for implementing one or more components in FIG. 1, according to an embodiment. In various embodiments, the communication device may include a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 700 in a manner as follows.

Computer system 700 includes a bus 702 or other communication mechanism for communicating information data, signals, and information between various components of computer system 700. Components include an input/output (I/O) component 704 that processes a user action, such as selecting keys from a keypad/keyboard, selecting one or more buttons, image, or links, and/or moving one or more images, etc., and sends a corresponding signal to bus 702. I/O component 704 may also include an output component, such as a display 711 and a cursor control 713 (such as a keyboard, keypad, mouse, etc.). An optional audio/visual input/output component 705 may also be included to allow a user to use voice for inputting information by converting audio signals. Audio/visual I/O component 705 may allow the user to hear audio, and well as input and/or output video. A transceiver or network interface 706 transmits and receives signals between computer system 700 and other devices, such as another communication device, service device, or a service provider server via network 140. In one embodiment, the transmission is wireless, although other transmission mediums and methods may also be suitable. One or more processors 712, which can be a micro-controller, digital signal processor (DSP), or other processing component, processes these various signals, such as for display on computer system 700 or transmission to other devices via a communication link 718. Processor(s) 712 may also control transmission of information, such as cookies or IP addresses, to other devices.

Components of computer system 700 also include a system memory component 714 (e.g., RAM), a static storage component 716 (e.g., ROM), and/or a disk drive 717. Computer system 700 performs specific operations by processor(s) 712 and other components by executing one or more sequences of instructions contained in system memory component 714. Logic may be encoded in a computer readable medium, which may refer to any medium that participates in providing instructions to processor(s) 712 for execution. Such a medium may take many forms, including but not limited to, non-volatile media, volatile media, and transmission media. In various embodiments, non-volatile media includes optical or magnetic disks, volatile media includes dynamic memory, such as system memory component 714, and transmission media includes coaxial cables, copper wire, and fiber optics, including wires that include bus 702. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 700. In various other embodiments of the present disclosure, a plurality of computer systems 700 coupled by communication link 718 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components including software, hardware, and/or both without departing from the spirit of the present disclosure. Where applicable, the various hardware components and/or software components set forth herein may be separated into sub-components including software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Although illustrative embodiments have been shown and described, a wide range of modifications, changes and substitutions are contemplated in the foregoing disclosure and in some instances, some features of the embodiments may be employed without a corresponding use of other features. One of ordinary skill in the art would recognize many variations, alternatives, and modifications of the foregoing disclosure. Thus, the scope of the present application should be limited only by the following claims, and it is appropriate that the claims be construed broadly and in a manner consistent with the scope of the embodiments disclosed herein.

What is claimed is:

1. A machine learning system configured to induce neuron activity in a neural network of the machine learning system, the machine learning system comprising:
a processor and a computer readable medium operably coupled thereto, the computer readable medium comprising a plurality of instructions stored in association therewith that are accessible to, and executable by, the processor, to perform selective neuron inducement operations which comprise:
selecting the neural network comprising a multilayer perceptron having activation functions and weights for activation of perceptrons in the multilayer perceptron and one or more predictive outputs by the perceptrons;
performing an incremental learning cycle on the multilayer perceptron, wherein performing the incremental learning cycle comprises:
selecting a first input neuron to modify by strengthening first connections of the first input neuron to additional neurons in the multilayer perceptron;
selecting a second input neuron to modify by weakening second connections of the second input neuron to the additional neurons in the multilayer perceptron;
adjusting, based on the first input neuron and the second input neuron, activation function thresholds of the activation functions and the weights associated with the additional neurons for the first input neuron and the second input neuron in the multilayer perceptron; and
running batches of input data through the multilayer perceptron until a set constraint is met, wherein a prediction is generated for each of the batches from input data from the neural network based on the adjusting.

2. The machine learning system of claim 1, wherein the set constraint comprises a predetermined number of passes through each neuron within the multilayer perceptron.

3. The machine learning system of claim 2, wherein the predetermined number of passes comprises a sum of forward passes and backpropagation passes through each neuron in the multilayer perceptron.

4. The machine learning system of claim 1, wherein the adjusting the activation function thresholds comprises adjusting a threshold of a first additional neuron selected from the additional neurons based on a first chance of the first additional neuron activating from the running the batches of the input data, wherein the first chance increases a likelihood that the first additional neuron outputs data.

5. The machine learning system of claim 4, wherein the adjusting the activation function thresholds comprises adjusting the threshold of a second additional neuron selected from the additional neurons based on a second chance of the second additional neuron activating from the running the batches of the input data, wherein the second chance decreases a likelihood that the second additional neuron outputs data.

6. The machine learning system of claim 1, wherein the batches of the input data are collected from one or more online data sources, and wherein the running of the batches is performed with the neural network in real-time when streaming the batches of the input data from the one or more online data sources.

7. The machine learning system of claim 1, wherein, after the set constraint is met, the activation function thresholds and the weights of the first input neuron and the second input neuron are reset to random values.

8. The machine learning system of claim 1, wherein the incremental learning cycle is repeated with at least one or more different input neurons after selecting the first input neuron and the second input neuron for the adjusting.

9. A method to induce neuron activity in a neural network of a machine learning system, the method comprising:
selecting the neural network comprising a multilayer perceptron having activation functions and weights for activation of perceptrons in the multilayer perceptron and one or more predictive outputs by the perceptrons;
performing an incremental learning cycle on the multilayer perceptron, wherein performing the incremental learning cycle comprises:
selecting a first input neuron to modify by strengthening first connections of the first input neuron to additional neurons in the multilayer perceptron;
selecting a second input neuron to modify by weakening second connections of the second input neuron to the additional neurons in the multilayer perceptron;
adjusting, based on the first input neuron and the second input neuron, activation function thresholds of the activation functions and the weights associated with the additional neurons for the first input neuron and the second input neuron in the multilayer perceptron; and
running batches of input data through the multilayer perceptron until a set constraint is met, wherein a prediction is generated for each of the batches from input data from the neural network based on the adjusting.

10. The method of claim 9, wherein the set constraint comprises a predetermined number of passes through each neuron within the multilayer perceptron.

11. The method of claim 10, wherein the predetermined number of passes comprises a sum of forward passes and backpropagation passes through each neuron in the multilayer perceptron.

12. The method of claim 9, wherein the adjusting the activation function thresholds comprises adjusting a threshold of a first additional neuron selected from the additional neurons based on a first chance of the first additional neuron activating from the running the batches of the input data, wherein the first chance increases a likelihood that the first additional neuron outputs data.

13. The method of claim 12, wherein the adjusting the activation function thresholds comprises adjusting the threshold of a second additional neuron selected from the additional neurons based on a second chance of the second additional neuron activating from the running the batches of the input data, wherein the second chance decreases a likelihood that the second additional neuron outputs data.

14. The method of claim 9, wherein the batches of the input data are collected from one or more online data sources, and wherein the running of the batches is performed with the neural network in real-time when streaming the batches of the input data from the one or more online data sources.

15. The method of claim 9, wherein, after the set constraint is met, the activation function thresholds and the weights of the first input neuron and the second input neuron are reset to random values.

16. The method of claim 9, wherein the incremental learning cycle is repeated with at least one or more different input neurons after selecting the first input neuron and the second input neuron for the adjusting.

17. A non-transitory computer-readable medium having stored thereon computer-readable instructions executable to induce neuron activity in a neural network of a machine learning system, the computer-readable instructions executable to perform selective neuron inducement operations which comprises:
selecting the neural network comprising a multilayer perceptron having activation functions and weights for activation of perceptrons in the multilayer perceptron and one or more predictive outputs by the perceptrons;
performing an incremental learning cycle on the multilayer perceptron, wherein performing the incremental learning cycle comprises:
selecting a first input neuron to modify by strengthening first connections of the first input neuron to additional neurons in the multilayer perceptron;
selecting a second input neuron to modify by weakening second connections of the second input neuron to the additional neurons in the multilayer perceptron;
adjusting, based on the first input neuron and the second input neuron, activation function thresholds of the activation functions and the weights associated with the additional neurons for the first input neuron and the second input neuron in the multilayer perceptron; and
running batches of input data through the multilayer perceptron until a set constraint is met, wherein a prediction is generated for each of the batches from input data from the neural network based on the adjusting.

18. The non-transitory computer-readable medium of claim 17, wherein the set constraint comprises a predetermined number of passes through each neuron within the multilayer perceptron.

19. The non-transitory computer-readable medium of claim 18, wherein the predetermined number of passes comprises a sum of forward passes and backpropagation passes through each neuron in the multilayer perceptron.

20. The non-transitory computer-readable medium of claim 17, wherein the adjusting the activation function thresholds comprises adjusting a threshold of a first additional neuron selected from the additional neurons based on a first chance of the first additional neuron activating from the running the batches of the input data, wherein the first chance increases a likelihood that the first additional neuron outputs data.
